(19) United States
(12) Patent Application Publication
(10) Pub. No.: US 2019/0210707 A1
(43) Pub. Date: Jul. 11, 2019

(54) AIRCRAFT PANEL AND METHOD OF CONSTRUCTING

(71) Applicant: ISRAEL AEROSPACE INDUSTRIES LTD., Lod (IL)

(72) Inventor: Haim Korach, Tel Aviv (IL)

(21) Appl. No.: 15/778,569

(22) PCT Filed: Nov. 22, 2016
(86) PCT No.: PCT/IL2016/051249

§ 371 Date: May 23, 2018

(30) Foreign Application Priority Data
Nov. 24, 2015 (IL) 242749

(51) Int. Cl. B64C 1/12; B64F 5/10; B64C 1/06

(52) U.S. Cl. CPC B64C 1/12; B64F 5/10; B64C 2001/0081; B64C 1/064; B64C 1/061

(57) ABSTRACT

A method of constructing a panel for an aircraft subassembly is provided. The panel has interior and exterior sides relative to the subassembly and comprises a skin and a support structure. The support structure comprises a plurality of longerons and frames constituting support-structure elements and arranged substantially in a grid, and projecting substantially transversely from the skin toward the interior side. The method comprises providing a flat sheet of structural material, wherein the sheet comprises one or more cutouts, and forming the support structure by folding the sheet, wherein the longerons and frames are formed from overfolded areas of the sheet adjacent the cutouts, and wherein non-overfolded areas of the sheet constitute the skin.

### TECHNOLOGICAL FIELD

The presently disclosed subject matter relates to panels and methods of constructing them. In particularly, it relates to panels for use in aircraft subassemblies and methods of constructing such them.

### BACKGROUND

Aircraft, for example airplanes, are typically constructed using a semi-monocoque structure, wherein an external skin is supported by an internal structure. The internal structure comprises radial frames and longitudinally-extending longerons.

An industrial process to assemble such a structure involves many processes and logistical steps, including provisioning many parts from suppliers, storage thereof, and coordinating providing the required parts to a technician for assembly of the structure.

### SUMMARY

According to one aspect of the presently-disclosed subject matter, there is provided a method of constructing a panel for an aircraft subassembly, wherein the panel has interior and exterior sides relative to the subassembly and comprises:
a skin; and
a support structure, the support structure comprising a plurality of longerons and frames constituting support-structure elements and being arranged substantially in a grid and projecting substantially transversely from the skin toward the interior side;
   the method comprising:
providing a flat sheet of structural material, wherein the sheet comprises one or more cutouts; and
forming the support structure by folding the sheet, wherein the longerons and frames are formed from overfolded areas of the sheet adjacent the cutouts, and wherein non-overfolded areas of the sheet constitute the skin.

It will be appreciated that herein the specification and claims, the term “longeron” includes any similar longitudinally disposed structural member, such as stiffeners, stringers, etc., without departing from the scope of the presently disclosed subject matter. Similarly, the term “frame” includes any similar laterally and/or radially disposed structural member, such as formers, etc., without departing from the scope of the presently disclosed subject matter.

It will be further appreciated that herein the specification and claims, terms such as “forming,” “folding,” curving,” related forms thereof, and other similar terms are used as descriptive only, and are not intended to be limiting to any one or more industrial processes, for example having the same name.

It will be still further appreciated that herein the specification and claims, the term “flat” is to be construed as defining a relatively thin piece of material, for example being substantially free of marked projections and/or depressions, and which may be planar or curved along one or more axes.

The method may further comprise scoring the sheet prior to the folding.

The forming may further comprise welding at least some of the overfolded areas.

The forming may further comprise providing a filler material at an external seam, constituting a welding seam, between the overfolded areas.

The welding may comprise one or more of laser beam welding, pulse welding (e.g., pulse resistance welding), spot welding, and spot laser welding.

The forming may further comprise introducing an insert within each of at least some intersections of longerons and frames.

Each of the inserts may have a cruciform cross-section.

The forming may further comprise folding distal edges of at least some of the support-structure elements.

The subassembly may at least partially define a portion, for example an aft fuselage or an empennage, of the aircraft which remains unpressurized during flight, i.e., a flight in which some portions of the aircraft are at least partially pressurized.

The structural material may be a metal. For example, it may be an aluminum alloy, such as 6013 aluminum. The metal may be characterized by (i.e., it may meet the requirements of) a T4 temper designation.

The method may further comprise age hardening the panel after the forming of the support structure.

The age hardening may comprise heat treating the panel to a T6 temper designation.

The panel may constitute part of a semi-monocoque structure of the subassembly.

The frames may project inwardly farther than the longerons.

The forming may further comprise curving the panel, for example about an axis substantially parallel to the longerons.

The method may further comprise performing coupon testing on the panel.

The method may further comprise performing load testing on the panel. The load testing may be performed with one or more integral stiffeners. The method may further comprise repeating the load testing under different load conditions.

The method may further comprise testing mechanical properties of the subassembly.

The method may further comprise performing one or more technological demonstrators for manufacturing validation.

According to another aspect of the presently disclosed subject matter, there is provided a panel for an aircraft subassembly, the panel comprising a skin and a support structure, the support structure comprising a plurality of longerons and frames constituting support-structure elements and being arranged substantially in a grid and projecting substantially transversely from the skin toward an interior side, the panel being formed from a folded flat sheet of structural material, wherein overfolded areas of the sheet constitute the support structure, and wherein non-overfolded areas of the sheet constitutes the skin.

At least some of the overfolded areas may be welded.

The panel may further comprise a filler material at an external seam between the overfolded areas.

The panel may further comprise an insert within at least some intersections of longerons and frames.

Each of the inserts may have a cruciform cross-section.

Distal edges of at least some of the support-structure elements may be folded.

The subassembly may at least partially define a portion, such as an aft fuselage or an empennage, of the aircraft which remains unpressurized during flight.

The structural material may be a metal. For example, it may be an aluminum alloy, such as 6013 aluminum. The metal may be characterized by a T6 temper designation.

The panel may constitute part of a semi-monocoque structure of the subassembly.

The frames may project inwardly farther than the longerons.

The panel may be curved, for example about an axis substantially parallel to the longerons.

According to a further aspect of the presently disclosed subject matter, there is provided a method of constructing a subassembly of an aircraft, comprising constructing a panel as described above.

According to a still further aspect of the presently disclosed subject matter, there is provided a subassembly of an aircraft, comprising a panel as described above.

According to a still further aspect of the presently disclosed subject matter, there is provided a sheet for constructing a panel for an aircraft subassembly, the panel having interior and exterior sides relative to the subassembly and comprising:
a skin; and
a support structure comprising a plurality of longerons and frames arranged substantially in a grid and projecting substantially transversely from the skin toward the interior side;
   the sheet being flat and comprising one or more cutouts formed substantially in a grid and at least partially defining longeron-portions and frame-portions configured to constitute the support-structure when the sheet is folded to construct the panel.

At least some of the longeron-portions and frame-portions may be at least partially defined between adjacent cutouts.

At least some of the longeron-portions and frame-portions may be at least partially defined between cutouts and an edge of the sheet.

The sheet may further comprise a forming tool reference partially defining, with the cutouts, the longeron-portions and frame-portions.

The forming tool reference may comprises:
pairs of longeron-base scoring partially defining therebetween, with the cutouts, the longeron-portions; and
pairs of frame-base scoring partially defining therebetween, with the cutouts, the frame-portions;
   wherein skin-portions, configured to constitute the skin when the sheet is folded to construct the panel, are defined between longeron-base and frame-base scoring.

The cutouts may be substantially rectangular.

The sheet may be made of a metal. For example, it may be an aluminum alloy, such as 6013 aluminum. The metal may be characterized by (i.e., it may meet the requirements of) a T4 temper designation.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A and 1B are perspective views of panels according to the presently disclosed subject matter;

FIG. 2 is a plan view of a sheet used to construct panels such as illustrated in FIGS. 1A and 1B;

FIG. 3 is a close-up of the area indicated at III in FIG. 2;

FIG. 4 is a side sectional view of a distal edge of a modification of support-structure element of the panels illustrated in FIGS. 1A and 1B;

FIG. 5A is a close-up perspective view of an exterior side of an intersection of support-structure elements of the panels illustrated in FIGS. 1A and 1B;

FIG. 5B is a close-up perspective view of an interior side of the intersection illustrated in FIG. 5A;

FIG. 5C is a perspective view of an insert;

FIG. 6 is a side section view of an example of a support-structure element of the panels illustrated in FIGS. 1A and 1B; and

FIG. 7 is a cross-sectional view of a seam of a support-structure element of the panels illustrated in FIGS. 1A and 1B.

### DETAILED DESCRIPTION

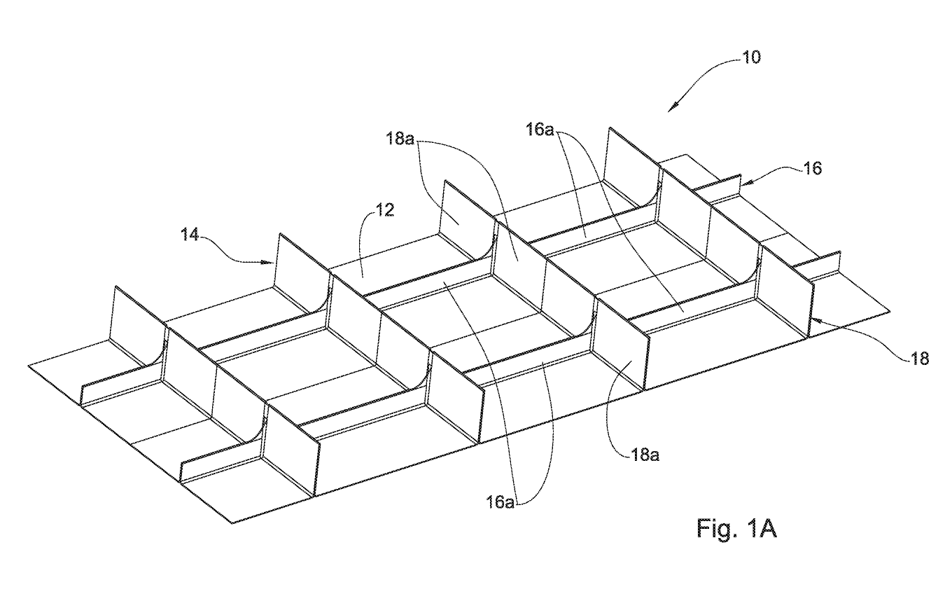

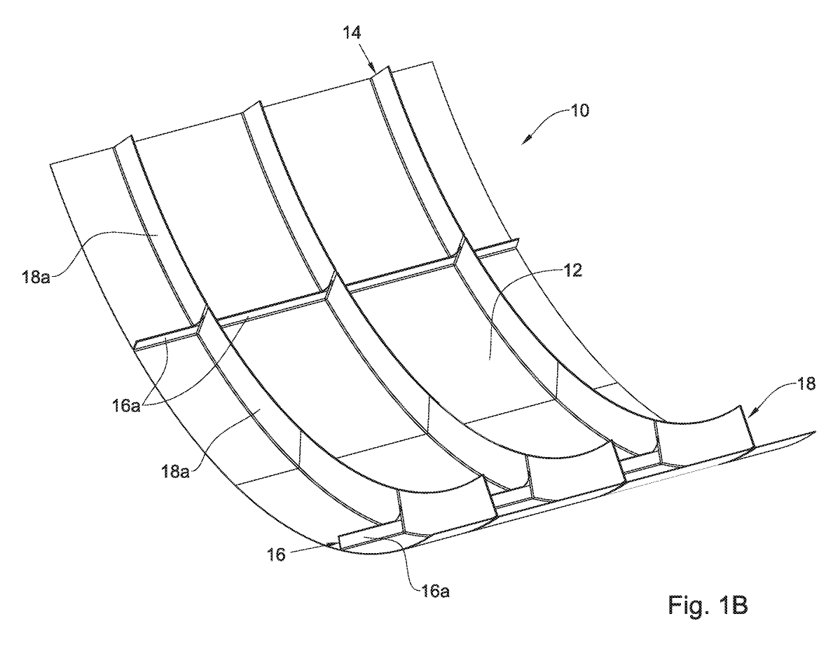

As illustrated in FIGS. 1A and 1B, there is provided a panel, which is generally indicated at 10, for use as part of an aircraft subassembly, which may comprise a semi-monocoque structure, such as part of an exterior panel thereof. The subassembly may be, for example, one which is not pressurized or not fully pressurized during flight (i.e., when compared to other parts of the aircraft, such as the cockpit, fuselage, etc.). According to some examples, the subassembly is a component of an airplane aft fuselage or an empennage. According to some modifications, the panel 10 is an external panel, such as a skin panel, of the subassembly.

The panel 10 comprises a skin 12 and a support structure 14. The support structure comprises a plurality of support-structure elements arranged substantially in a grip, and projecting transversely inwardly from the skin. It will be appreciated that the terms “inward,” “interior,” “outward,” “exterior,” and variation thereof are used herein the specification and claims as a convention which based on the most typical orientation of the panel when assembled with the aircraft, and should not be construed as limiting the presently disclosed subject matter to any particular orientation thereof in practice.

The support-structure elements comprise a plurality of longerons 16, and a plurality of frames 18, which may project inwardly farther than the longerons do. The longerons 16 comprise a plurality of longitudinally-arranged longeron elements 16a. Similarly, the frames 18 comprise a plurality of radially-arranged frame elements 18a.

The longerons 16 may be arranged parallely, such that they taper toward each other, or any other suitable configuration. Similarly, the frames may be arranged parallely to each other, or in any other suitable configuration.

As seen in FIG. 1B, the panel 10 may be formed having a desired curved shape, for example as may be suitable for the hull of a generally cylindrical aircraft, such as a commercial airplane. Accordingly, the curvature may be about an axis (not illustrated) which is substantially parallel to the longerons 16 (e.g., a longitudinal axis of a commercial airplane). According to some examples (not illustrated), the panel 10 may be curved about more than one axis, e.g., being substantially transverse to each other.

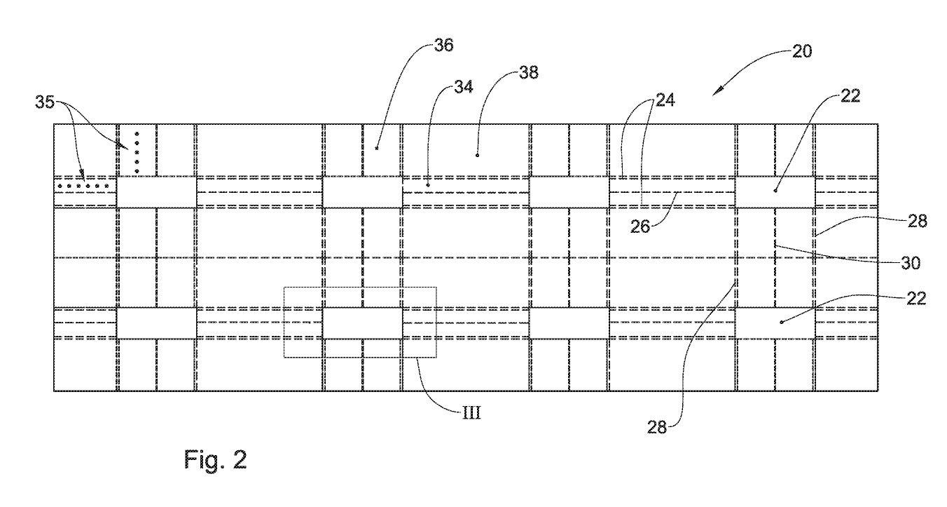

The panel 10 as illustrated in FIG. 1A is constructed using a flat sheet 20 of structural material, for example as illustrated in FIG. 2. Used herein, the term “structural material” in intended to encompass materials which are suitable for withstanding the conditions (e.g., loads, temperatures, exposure to corrosives, etc.) that an aircraft is typically subject to during use, and/or which may undergo a process to be made suitable therefor. For example, the material may be a metal, such as an aluminum alloy. According to some examples, the aluminum alloy is Al-6013, which may be provided in a T4 temper designation, as is known in the art.

The sheet 20 is formed with, e.g., rectangular cutouts 22, for example in a grid pattern as shown. In addition, a forming tool reference, comprising a plurality of scoring lines, for example as described below, is provided on one or both surfaces of the sheet 20, in order to facilitate the folding. The forming tool reference may comprise:
longeron-base scoring 24, spanning parallely to each other between corners of the cutouts 22;
longeron-edge scoring 26, spanning parallely to the longeron-base scoring 24 between midpoints of the cutouts 22;
frame-base scoring 28, spanning parallely to each other between corners of the cutouts 22 and transversely to the longeron-base scoring 24; and
frame-edge scoring 30, spanning parallely to the frame-base scoring 28 between midpoints of the cutouts 22.

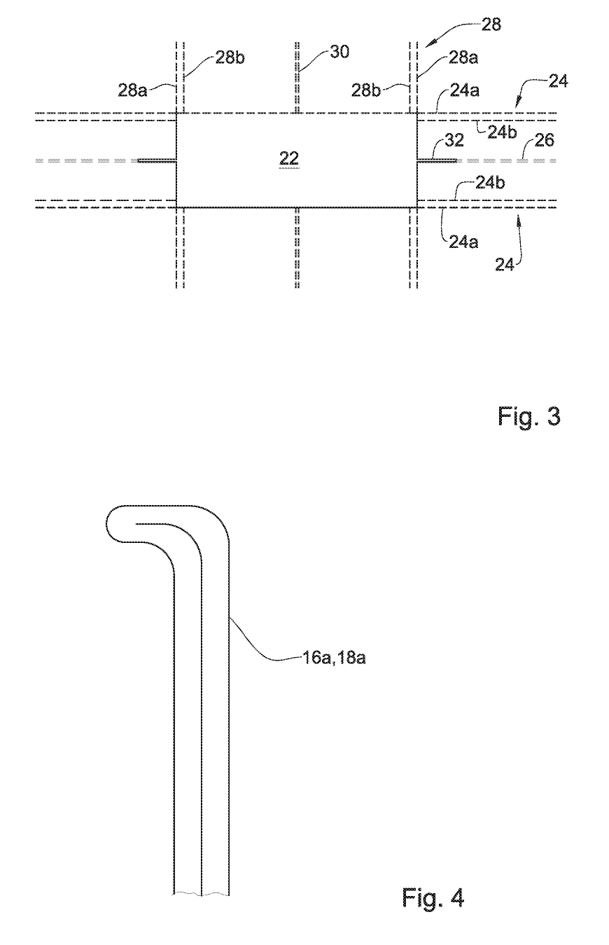

Some or all of the scoring may comprise a double-score, i.e., two closely-formed parallel score lines, for example to form, when the sheet 20 is folded, a chamfer at the base of at least some of the support-structure elements, as described below. As best seen in FIG. 3, when the longeron-base scoring 24 and/or frame-base scoring 28 is thus formed, the double-score may comprise a first score line 24a, 28a lying substantially in registration (i.e., collinear) with an edge of its adjacent cutout 22, and a second score line 24b, 28b abutting the adjacent edge of the cutout.

Optionally, a slot 32 may be formed at ends of the some of the longeron-edge scoring 26 (as shown) and/or frame-edge scoring 30. The slot 32 may be formed by removing material of the sheet 20 (as shown), or by cutting the sheet substantially without removing any of the material thereof.

Reverting to FIG. 2, the forming tool reference and cutouts 22 define areas of the sheet 20 which, after folding, become different elements of the panel 10. For example:
rectangular longeron-portions 34 of the sheet 20 are defined, on two opposite sides, between adjacent longeron-base scoring 24 and, on two other opposite sides, the cutouts 22 between which the two longeron-base scoring span;
rectangular frame-portions 36 of the sheet 20 are defined, on two opposite sides, between adjacent frame-base scoring 28 and, on two other opposite sides, the cutouts 22 between which the two frame-base scoring span; and
rectangular skin-portions 38 of the sheet 20 are defined, on two opposite sides, between two longeron-portions 34, and, on two other opposite sides, between two frame-portions 36.

It will be appreciated that the above descriptions of the scorings 24, 26, 28, 30 and the rectangular portions 34, 36, 38 are made with reference to features of the sheet 20 which are not present at edges, and that in those cases, some of the defining features disclosed above are replaced by the edge of the sheet, mutatis mutandis. E.g., longeron-base scoring 24 adjacent the edge of the sheet 20 span parallely to each other between, on the one hand, corners of the cutouts 22, and on the other hand the edge of the sheet.

The longeron-portions 34 and/or frame-portions 36 may comprise welding apertures 35, only some of which are shown in order to maintain clarity of the figure, although it will be appreciated that some or all of the portions 34, 36 may be formed with such welding apertures. The welding apertures may be arranged in one or more lines parallel to the edge scorings 26, 30. The purpose of the welding apertures 35 will be discussed below.

Features of a sheet 20 provided to construct a curved panel 10, such as illustrated in FIG. 1B, may differ from those described above with reference to FIG. 2. For example, the shape of cutouts 22 thereof may have a non-rectangular shape, the shape of the forming tool reference may be suitably provided, etc., mutatis mutandis, as required to form the final shape of the panel 10 through folding.

To construct the panel 10, the sheet 20 is folded, with the forming tool reference facilitating it being properly folded to form the panel 10. Halves of each of the longeron-portions 34 which are separated from each other by the longeron-edge scoring 26 overfold (i.e., are folded over) each other to form a longeron element 16a, with the longeron-edge scoring becoming a distal (i.e., interior) edge thereof. Similarly, halves of each of the frame-portions 36 which are separated from each other by the frame-edge scoring 30 overfold each other to form a frame element 18a, with the frame-edge scoring becoming a distal edge thereof. The skin portions 38 are brought together, thereby becoming the skin 12 of the panel.

The folding may be accomplished by any suitable method or combination of methods, including, but not limited to, manually by a human technician, a suitably-configured machine and/robot, etc., and may include the use of a suitable designed template (not illustrated). Subsequently, as illustrated in FIG. 4, some or all of the distal edges of the longeron and or frame elements 16a, 18a may be folded transversely to the direction of projection from the skin, for example to increase the stiffness thereof.

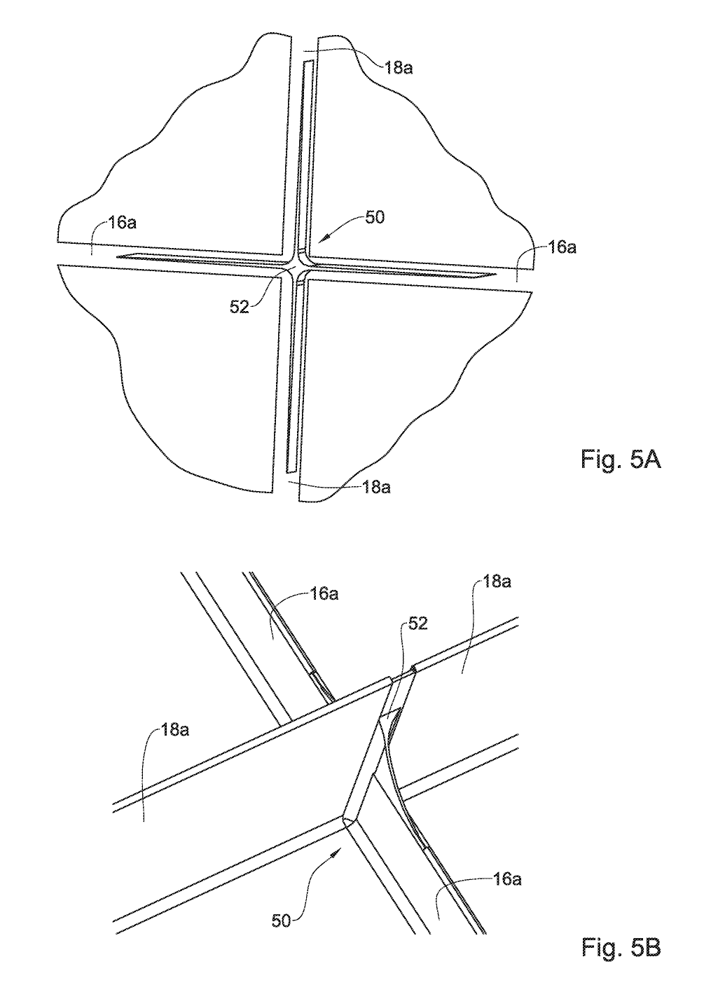

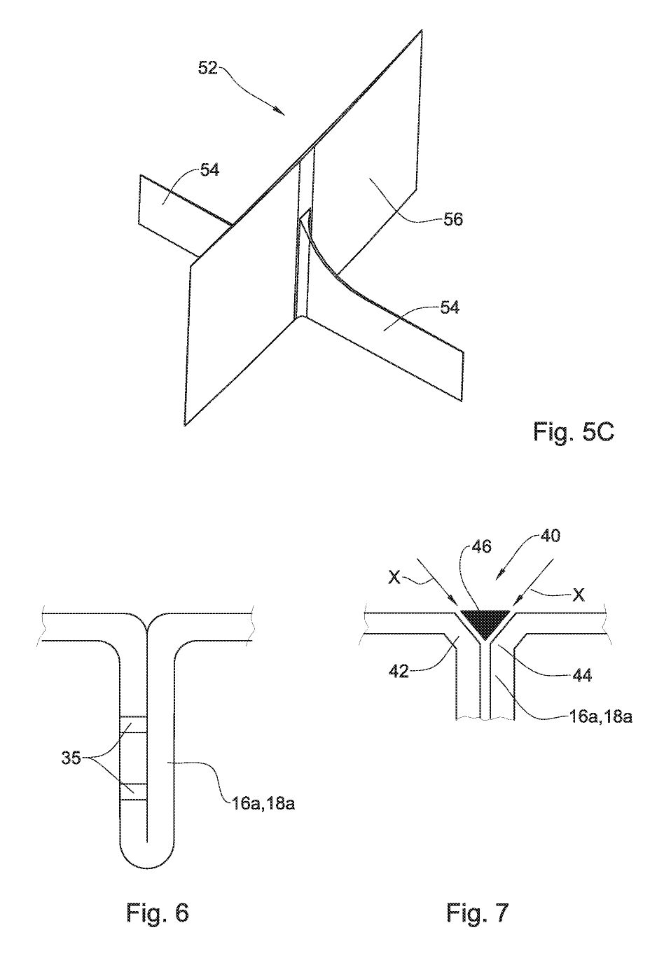

As illustrated in FIGS. 5A and 5B, intersections 50 of longerons 16 and frames 18 may be provided with inserts 50, introduced thereto from an external side thereof. The inserts 52 may be welded to the longerons 16, frames 18, and/or skin 12, or otherwise secured thereto. The inserts 52 constitute a continuous core at the intersections 50, which may facilitate maintaining and/or increasing mechanical properties of the panel 10.

As seen in FIG. 5C, each of the inserts 52 may comprise flat longeron support members 54 disposed transversely to an optionally taller flat frame support member 56, imparting a substantially cruciform cross-section to the insert. When the insert 52 is introduced into an intersection 50, the longeron support members 54 lie within (i.e., within the constituent overfolded longeron-portions 34 thereof) adjacent longeron elements 16a, and the frame support members 56 lie within adjacent frame elements 18a.

According to some examples, for example as best seen in FIG. 5B, the inserts 52 are formed so as to extend the entire heights of the longerons 16 and/or frames 18. Accordingly, the inserts 52 may provide a continuous core in an area where the material (i.e., edges of longeron- and frame elements 16a, 18a) are otherwise held together only by welding to each other. The edges of the longeron- and frame elements 16a, 18a, may thus be welded to their adjacent insert.

According to other examples, the inserts 52 are formed so as to extend only partially along the heights of the longerons 16 and/or frames 18.

The overfolded areas (i.e., the longeron- and frame-portions 34, 36) which form elements 16a, 18a of the support structure 14 may be at least partially connected together, for example by spot welding, which may be performed as pulsed welding, with any suitable overlap, for example at least 75%. Welding may be performed to connect at least some of the longeron- and frame-portions 34, 36 to inserts 52.

As illustrated in FIG. 6, according to examples wherein the sheet 20 is formed with welding apertures 35, the overfolded areas which form elements 16a, 18a of the support structure 14 may be welded together using laser welding, wherein the welding apertures 35 constitute targets in the laser welding process, thereby facilitating the connection of the overfolded areas.

As illustrated in FIG. 7, external seams 40 of the panel 10, formed on external sides of the panel at distal edges of the longeron and frame elements 16a, 18a, are welded closed. This may be accomplished by laser beam welding. According to examples wherein some or all of the base scorings 24, 28 comprise a double-score, for example as described above with reference to FIG. 3, each of the overfolded areas of the longeron- and frame-portions 34, 36 may be formed forming a chamfer 42, giving rise to a channel 44 therebetween. A filler rod 46, optionally having a profile which at least partially matches that of the channel 44, is disposed within the channel. (Herein the specification and claims, the term “filler rod” may include any other appropriate material which is provided to similarly facilitate a welding process, such as filler wire, etc.) A laser beam is applied, for example at an orientation along each of the chamfers 42 (indicated by arrows X), thereby joining the sides of the channel 44 to the filler rod. The use of a filler rod 46 to facilitate welding may facilitate an improved welding geometry, thereby increasing the strength thereof.

After the panel 10 is formed, it may be age hardened, for example to improve mechanical properties thereof. According to some example, for example wherein the material of the sheet 20 used to form the panel 10 is provided in a T4 temper designation, the panel may be age hardened, for example by any suitable method well-known in the art, to a T6 temper designation.

Subsequently, the panel 10 and/or subassembly may undergo any necessary steps required to receive certification for use in an aircraft. These step may include, but are not limited to, one or more of:
coupon (i.e., fatigue) testing, e.g., to determine mechanical properties of welding seams;
load testing of panels, e.g., with integral stiffeners under various load conditions;
full scale testing, for example of a subassembly or entire aircraft which includes one or more panels 10 according to the presently disclosed subject matter; and
one or more technological demonstrators for manufacturing validation.

A panel 10 as disclosed above may be produced substantially without the use of fastening members such as rivets, etc. In addition, as the skin 12 and support structure 14 are made from a single element (i.e., the sheet 20), and as a bulk material such as the filler rod 46 partially replaces fastening members, fewer parts are required to assemble it than would be if longerons and frames were to be assembled from separate parts, e.g., connected to the skin. The reduction in parts needed to assemble the panel 10 (including for the frames and longerons, as well as fastening members) may simplify the logistics involved in assembling the panel 10, in particular reducing/eliminating steps connected with provisioning parts (e.g., from a supplier) and providing them to a technician for assembly of the panel. The simplification of the logistics may reduce the time and/or cost required to assemble the panel 10, and thus the subassembly.

It will be appreciated that although the foregoing description is directed toward an example wherein the panel is part of an aircraft subassembly, such a disclosure should not be construed as limiting. A panel similar to that that described above, for example made by essentially the same or a similar method, may be provided and configured for used for any suitable purpose, mutatis mutandis, without departing from the scope of the presently disclosed subject matter.

Those skilled in the art to which this invention pertains will readily appreciate that numerous changes, variations and modifications can be made without departing from the scope of the invention mutatis mutandis.

1-55. (canceled)

56. A method of constructing a panel for an aircraft subassembly, wherein said panel has interior and exterior sides relative to said aircraft subassembly and includes:
a skin; and
a support structure including a plurality of longerons and frames constituting support-structure elements and arranged substantially in a grid and projecting substantially transversely from said skin toward the interior side;
the method comprising:
providing a flat sheet of structural material, wherein said flat sheet of structural material comprises one or more cutouts; and
forming said support structure by folding said flat sheet of structural material, wherein said plurality of longerons and frames are formed from overfolded areas of the flat sheet of structural material adjacent said cutouts;
wherein non-overfolded areas of the flat sheet of structural material constitute said skin.

57. The method according to claim 56, further comprising scoring said flat sheet of structural material prior to the folding.

58. The method according to claim 56, wherein said forming comprises welding at least some of said overfolded areas.

59. The method according to claim 56, wherein said forming comprises introducing an insert within each of at least some intersections of the plurality of longerons and frames.

60. The method according to claim 59, wherein each of said inserts has a cruciform cross-section.

61. The method according to claim 56, wherein said forming comprises folding distal edges of at least some of said support-structure elements.

62. The method according to claim 56, wherein said structural material includes 6013 aluminum characterized by a T4 temper designation, the method further comprising age hardening said panel after the forming of the support structure.

63. The method according to claim 62, wherein said age hardening comprises heat treating to a T6 temper designation.

64. The method according to claim 56, wherein said panel constitutes part of a semi-monocoque structure of said aircraft subassembly.

65. The method according to claim 56, wherein said frames project inwardly farther than said plurality of longerons.

66. The method according to claim 56, wherein said forming comprises curving said panel.

67. A method of constructing a subassembly of an aircraft, comprising constructing the panel according to the method of claim 56.

68. A panel for an aircraft subassembly, said panel comprising:
a skin; and
a support structure including a plurality of longerons and frames constituting support-structure elements and being arranged substantially in a grid and projecting substantially transversely from said skin toward an interior side;
wherein said panel is formed from a folded flat sheet of structural material, wherein overfolded areas of the folded flat sheet of structural material constitute said support structure;
wherein non-overfolded areas of the folded flat sheet of structural material constitutes said skin.

69. The panel according to claim 68, further comprising an insert within at least some intersections of plurality of longerons and frames.

70. The panel according to claim 68, wherein said panel constitutes part of a semi-monocoque structure of said aircraft subassembly.

71. The panel according to claim 68, wherein said frames project inwardly farther than said plurality of longerons.

72. The panel according to claim 68, being curved about an axis substantially parallel to said plurality of longerons.

73. A subassembly of an aircraft, comprising the panel according to claim 68.

74. A sheet for constructing a panel for an aircraft subassembly, the panel having interior and exterior sides relative to said subassembly and including:
a skin; and
a support structure including a plurality of longerons and frames arranged substantially in a grid and projecting substantially transversely from said skin toward the interior side;
said sheet comprising:
one or more cutouts formed substantially in a grid and at least partially defining longeron-portions and frame-portions configured to constitute said support structure when the sheet is folded to construct the panel;
wherein said sheet is flat.

75. The sheet according to claim 74, wherein at least some of said longeron-portions and frame-portions are at least partially defined between adjacent cutouts of the one or more cutouts.

76. The sheet according to claim 74, further comprising a forming tool reference partially defining, with said one or more cutouts, said longeron-portions and said frame-portions.

77. The sheet according to claim 76, wherein said forming tool reference comprises:
pairs of longeron-base scoring partially defining therebetween, with said cutouts, said longeron-portions; and
pairs of frame-base scoring partially defining therebetween, with said cutouts, said frame-portions;
wherein skin-portions, configured to constitute said skin when the sheet is folded to construct the panel, are defined between longeron-base and frame-base scoring.
